(19) United States
(12) Patent Application Publication
(10) Pub. No.: US 2022/0410908 A1
(43) Pub. Date: Dec. 29, 2022

(54) SYSTEM AND METHOD FOR CONTROLLING VEHICLE FUNCTIONS BASED ON EVALUATED DRIVING TEAM COMPOSITION

(71) Applicant: Bendix Commercial Vehicle Systems, LLC, Elyria, OH (US)

(72) Inventors: Hans MOLIN, Elyria, OH (US); Zheng LI, Elyria, OH (US); Karl JONES, Elyria, OH (US); Andreas KUEHNLE, Elyria, OH (US)

(21) Appl. No.: 17/361,725

(22) Filed: Jun. 29, 2021

(51) Int. Cl. B60W 40/09; G06K 9/00

(52) U.S. Cl. CPC B60W 40/09; G06K 9/00845; B60W 2040/0872

(57) ABSTRACT

A system for controlling vehicle functions based on monitored driving performance includes one or more sensors that capture performance-based data characterizing driving-performance implicating behaviors of a driving team during one or more driving campaigns. The performance-based data is analyzed according to one or more performance indicators to determine a compatibility score for the driving team that characterizes how driving team composition affects driving performance. One or more vehicle functions can then be controlled one or more vehicle functions based on compatibility scores for various driving teams.

### FIELD OF THE INVENTION

The invention relates to improvements in systems and methods for controlling vehicle functions based on monitored driving performance, and in particular based on evaluations of driving team composition effects on driving performance.

### BACKGROUND

Commercial vehicles are often driven by a driving team, which typically includes a driver and a passenger who may switch roles intermittently during driving excursions. The job of the commercial driving team is to drive, but the composition of the driving team may influence team driving performance such that the driving team is performing less than optimally (e.g., not reacting to road conditions properly or promptly enough, exhibiting unsafe behavior, etc.). Indeed, certain driver and passenger combinations may interact in ways that distract from the driving task.

Commercial fleet management is therefore benefited by determining which drivers/passengers should be teamed together, which should not be teamed together, which should or should not be teamed with anyone, and how driving team composition affects driving performance. Such determinations can then be utilized to make recommendations as to driving team compositions, or to otherwise control vehicle systems in response to the current driving team operating the vehicle. However, current systems do not provide for this.

Thus, there is a need in the art for a system and method that overcomes the deficiencies of these prior systems and methods.

### SUMMARY OF THE INVENTION

Systems and methods for controlling vehicle functions based on monitored driving performance are disclosed, in which the one or more performance indicators are analyzed to determine how circumstances—particularly driving team composition—affect driving performance. In general, driver and/or passenger behavior may be analyzed according to the one or more performance indicators, individually and/or as a driving team. The performance of a particular driving team is then compared to the performance of other driving teams, including driver-only or passenger only-teams, with respect to the one or more performance indicators, to identify the effects that driving team composition has on performance. It is then determined, based on the identified effects, which driving team compositions are relatively desirable or undesirable. One or more driving team recommendations can accordingly be made, and one or more vehicle systems can then be controlled based thereon.

In at least one embodiment, systems and methods for controlling vehicle functions based on monitored driving performance includes one or more sensors that capture performance-based data characterizing driving-performance implicating behaviors of a driving team during one or more driving campaigns. The performance-based data is analyzed according to one or more performance indicators to determine a compatibility score for the driving team that characterizes how driving team composition affects driving performance. One or more vehicle functions can then be controlled one or more vehicle functions based on compatibility scores for various driving teams.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an exemplary system, in accordance with one or more aspects of the invention;

FIG. 2 is a block diagram that illustrates an exemplary system architecture, in accordance with one or more aspects of the invention;

FIGS. 3A-B are diagrams illustrating exemplary driver-passenger interactions in accordance with one or more aspects of the invention;

FIGS. 4A-B are exemplary graphs characterizing historical driving behavior, in accordance with one or more aspects of the invention;

FIGS. 5A-B are exemplary statistical distributions characterizing historical driving behavior, in accordance with one or more aspects of the invention;

FIG. 6 is flow-chart illustrating an exemplary method, in accordance with one or more aspects of the invention;

FIG. 7 is an exemplary performance table characterizing driving team performance across a plurality of driving team compositions, in accordance with one or more aspects of the invention; and

FIG. 8 is flow-chart illustrating an exemplary method, in accordance with one or more aspects of the invention.

### DESCRIPTION OF EXEMPLARY EMBODIMENTS OF THE INVENTION

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

Further in accordance with the practices of persons skilled in the art, aspects of one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

In accordance with the descriptions herein, the term “computer readable medium,” as used herein, refers to any non-transitory media that participates in providing instructions to the processor for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like.

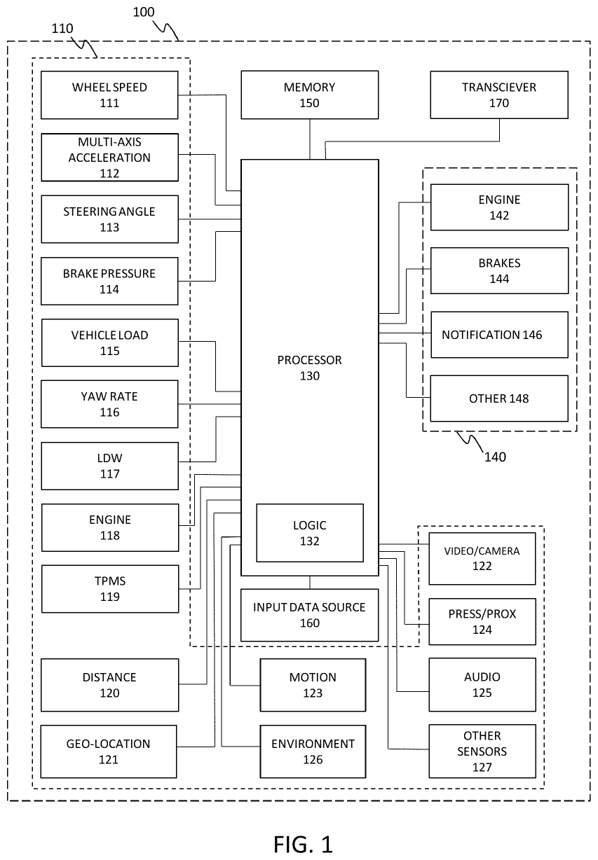

In addition, and further in accordance with the descriptions herein, the term “logic,” as used herein, particularly with respect to FIG. 1, includes hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components.

The invention relates generally to a driving team performance monitoring system that monitors the driving performance of one or more driving teams and recommends driving team compositions and/or controls one or more vehicle systems based on such performance. In certain embodiments, the invention may be implemented by an on-vehicle event detection and reporting system.

The event detection and reporting system may be configured to collect and provide event-based data corresponding to detected driver and/or vehicle related events occurring during a driving excursion, or even outside of the driving excursion. The event-based data can include vehicle and/or driver related data collected from components of, or components interacting with, the event detection and reporting system, including but not limited to vehicle devices, sensors and/or systems. It will be understood that, while aspects and embodiments are occasionally described herein in terms of the driver, or in terms of being driver related, such aspects and embodiments are also generally applicable to passengers in lieu of or in addition to drivers, except as will be apparent to those of ordinary skill.

The components may include one or more driver facing cameras configured such that the field of view of the camera(s) captures a view the driver of the vehicle, and/or a view of other areas of the cabin, such as the driver controls of the vehicle while driving and non-driver passenger areas. Other cameras may be configured to capture other scenes relative to the vehicle, including but not limited to scenes in front of the vehicle, behind the vehicle, to either side of the vehicle, etc.

The components may further include vehicle devices, sensors and/or systems configured to provide non-video data, including non-video event-based data corresponding to driver and/or vehicle related events. Such components may include one or more microphones, independent or in connection with the cameras, configured to capture audio recordings of areas of the cabin and/or other vehicle areas (e.g., engine noise, etc.).

Accordingly, the event detection and reporting system can detect, in real time, the driver and/or vehicle related events from the collected event data. The event data therefore can include data from which events can be detected will be appreciated, but can also include data that corresponds to the detected event but is not used to detect the event. The events and/or the event data can be recorded, stored, reported to, collected by, or otherwise communicated internally and/or externally by the event detection and reporting system

Examples of events that may be detected and/or reported to/collected by the event detection and reporting system include but are not limited to: safety events, for example and without limitation, excessive acceleration, excessive braking, exceeding speed limit, excessive curve speed, excessive lane departure, lane change without turn signal, loss of video tracking, LDW system warning, following distance (i.e., headway) alert, forward collision warning, collision mitigation braking, collision occurrence, etc., and non-safety events, for example and without limitation, the driver logging in/out of a vehicle telematics system, the driver/passenger entering/leaving the vehicle, the driver/passenger occupying/vacating the bunk area, the driver occupying/vacating the driver seat, the vehicle engine being on/off, the vehicle gear being in park/drive, the parking brake being on/off, etc. Non-safety events may also include theft events, for example and without limitation, the presence of an unauthorized occupant accessing the vehicle, etc.

The event detection and reporting system may use event data collected directly from vehicle devices, sensors, and/or systems, which may include event data collected from an analysis of vehicle video, to generate event datasets that correspond in time with one or more detected events. Event data generated for a detected event may be associated with captured video frames whose timeline spans or overlaps the time when the event was detected/collected. Event data generated from an event determined from processing of captured vehicle video may at least be associated with the video from which it was generated, but may also be associated with other captured video frames whose timelines span or overlap the time when the event was detected/collected (in these scenarios, the time may be calculated based on the video frame or frames from which the event object was derived).

The event detection and reporting system may be further configured to collect and provide performance-based data corresponding to detected performance indicators characterizing driving performance during the driving excursion. Similar to the event-based data, the performance-based data can include vehicle and/or driver related data collected from components of, or components interacting with, the event detection and reporting system, including but not limited to vehicle devices, sensors and/or systems. The event detection and reporting system may also similarly use the performance-based data to detect performance events, as a particular type of driver and/or vehicle related event, and to generate associated datasets that correspond in time with one or more detected events.

Accordingly, the components, individually and collectively, may be configured to detect, in real time, the performance indicators (and/or performance events), and/or to report such performance indicators (and/or performance events) to the detection and reporting system. Examples of performance indicators include but are not limited to: following distance (i.e., headway), driving smoothness, driver hand positioning (e.g., gestures), driver head position, fatigue metrics, vigilance and reaction time measurements, etc., and any other indicator tending to characterize driving performance—particularly with respect to potentially impaired and/or enhanced driving performance due to, for example, distraction, inattention, increased focus, co-piloting, or other behavior.

One or more records of the detected events and/or the data sets generated in association therewith may be stored as corresponding to individual drivers and/or driving teams detected during the driving excursion, a period thereof, or otherwise during a timespan associated with the driving excursion (e.g., recently prior or subsequent to the driving excursion). As used herein, a “driving team” refers to one or more individuals, each of whom at any time during the driving excursion may be the driver or the passenger, but for which there is at least one driver at any given time.

The detection of drivers and/or driving teams may be via vehicle telematics log-in, facial and/or person recognition, or any other mechanism or process—which may identify the detected driver as associated with identification data (e.g., a personal ID number, etc.). Accordingly, events may be detected, recorded and reported as associated with the appropriate driver(s) and/or driving team(s) based at least partially on the personal identification data.

The event detection and reporting system may further be configured to control one or more vehicle systems in response to detected events. Examples of such control include but are not limited to: providing one or more types of warnings (e.g., driver assistance system warnings, warnings to passengers in the cabin that the driver requires assistance, etc.), intervening in the operation of the vehicle (e.g., to initiate corrective action, to activate harm mitigating features, to assume autonomous control, etc.), setting driver/passenger authorizations for the driving excursion (e.g., via vehicle telematics, etc.), and alerting remote locations/devices (e.g., backend servers, dispatch center computers, mobile devices, etc.) of such events. A variety of corrective actions may be possible and multiple corrective actions may be initiated at the same time.

In at least some embodiments, the invention relates to the control of vehicle systems based on performance characterizations of individual and multi-person driving teams. In some embodiments, the characterizations of individual and multi-person driving teams is achieved by comparing measured performance indicators for the members of the driving team. The performance indicators for each driving team can be compared to other driving teams, including driver-only teams, to determine how driving team composition affects driving performance. Consequently, one or more of the vehicle systems can be controlled based on the driving team characterizations, so as to account for one or more undesirable and/or desirable effects on driving performance.

Referring to FIG. 1, by way of overview a schematic block diagram is provided illustrating details of an event detection and reporting system 100 configured to be used in accordance with one or more embodiments. The event detection and reporting system 100 may be adapted to detect a variety of operational parameters and conditions of the vehicle and the driver's interaction therewith (i.e., event-based data, performance-based data, etc.) and, based thereon, to determine if a driving and/or vehicle event has occurred (e.g., if one or more operational parameter/condition thresholds has been exceeded). The data related to detected events (i.e., event-based data or data sets) may then be stored and/or transmitted to a remote location/device (e.g., backend server, dispatch center computer, mobile device, etc.), and one or more vehicle systems can be controlled based thereon.

The event detection and reporting system 100 may include one or more devices or systems 110 for providing vehicle and/or driver related data, including data indicative of one or more operating parameters or one or more conditions of a commercial vehicle, its surroundings and/or its cabin occupants. The event detection and reporting system 100 may, alternatively or additionally, include a signal interface for receiving signals from the one or more devices or systems 114, which may be configured separate from system 100. For example, the devices 110 may be one or more sensors, such as but not limited to, one or more wheel speed sensors 111, one or more acceleration sensors such as multi-axis acceleration sensors 112, a steering angle sensor 113, a brake pressure sensor 114, one or more vehicle load sensors 115, a yaw rate sensor 116, a lane departure warning (LDW) sensor or system 117, one or more engine speed or condition sensors 118, and a tire pressure (TPMS) monitoring system 119. The event detection and reporting system 100 may also utilize additional devices or sensors, including for example a forward distance sensor and/or a rear distance sensor 120 (e.g., radar, lidar, etc.) and/or a geo-location sensor 121. Additional sensors for capturing driver related data may include one or more video sensors 122 and/or motion sensors 123, pressure or proximity sensors 124 located in one or more seats and/or driver controls (e.g., steering wheel, pedals, etc.), audio sensors 125, or other sensors configured to capture driver related data. The event detection and reporting system 100 may also utilize environmental sensors 126 for detecting circumstances related to the environment of the driving excursion, including for example, weather, road conditions, time of day, traffic conditions, etc. Other sensors 127, actuators and/or devices or combinations thereof may be used or otherwise provided as well, and one or more devices or sensors may be combined into a single unit as may be necessary and/or desired. For example, biometric sensors may be included for detecting biometric data of the vehicle occupants.

The event detection and reporting system 100 may also include a logic applying arrangement such as a controller or processor 130 and control logic 132, in communication with the one or more devices or systems. The processor 130 may include one or more inputs for receiving data from the devices or systems. The processor 130 may be adapted to process the data and compare the raw or processed data to one or more stored threshold values or desired averages or value ranges, or to process the data and compare the raw or processed data to one or more circumstance-dependent desired value, so as to detect one or more driver and/or vehicle related events.

The processor 130 may also include one or more outputs for delivering a control signal to one or more vehicle control systems 140 based on the detection of the event(s) and/or in response to vehicle and/or driver related data. The control signal may instruct the systems 140 to provide one or more types of driver assistance warnings (e.g., warnings relating to braking, obstacle avoidance, driver performance, passenger performance, etc.) and/or to intervene in the operation of the vehicle to initiate corrective action. For example, the processor 130 may generate and send the control signal to an engine electronic control unit 142 or an actuating device to reduce the engine throttle and slow the vehicle down. Further, the processor 130 may send the control signal to one or more vehicle brake systems 144 to selectively engage the brakes (e.g., a differential braking operation). A variety of corrective actions may be possible and multiple corrective actions may be initiated at the same time. It will be understood that such corrective actions need not be contemporaneous with detected events and/or event data, and may, additionally or alternatively, be responsive to one or more historical records of detected events and/or event data.

The vehicle control components may further include brake light(s) and other notification devices 146, which may be configured to provide warnings and/or notifications externally to the vehicle surroundings and/or internally to the vehicle occupants. Example warnings and/or notifications include: headway time/safe following distance warnings, lane departure warnings, warnings relating to braking and or obstacle avoidance events, warnings related to driver performance, warnings related to passenger performance, and any other type of warning or notification in furtherance of the embodiments described herein. Other vehicle control systems 148 may also be controlled in response to detected events and/or event data.

The event detection and reporting system 100 may also include a memory portion 150 for storing and accessing system information, such as for example the system control logic 132. The memory portion 150, however, may be separate from the processor 130. The sensors 110, controls 140 and/or processor 130 may be part of a preexisting system or use components of a preexisting system.

The event detection and reporting system 100 may also include a source of vehicle-related input data 160, which may be indicative of a configuration/condition of the commercial vehicle and/or its environmental circumstances (e.g., road conditions, geographic area conditions, etc.). The processor 130 may sense or estimate the configuration/condition and/or environmental circumstances of the vehicle based on the input data, and may select a control tuning mode or sensitivity based on the vehicle configuration/condition and/or environmental circumstances. The processor 130 may compare the operational data received from the sensors 110 to the information provided by the tuning. Such tuning may be useful, for example, where a distracting passenger is present while driving a heavily loaded vehicle. Such input data may be further useful in evaluating driving performance, as described herein. For example, the driving performance of one or more driving team may be evaluated with respect to common environmental circumstances (e.g., performance in less desirable geographic areas).

In addition, the event detection and reporting system 100 may be operatively coupled with one or more driver facing imaging devices, shown for simplicity and ease of illustration as a single driver facing camera 122 that is trained on the driver and/or trained on the interior of the cab of the commercial vehicle. However, it should be appreciated that one or more physical video cameras may be disposed on the vehicle such as, for example, a video camera on each corner of the vehicle, one or more cameras mounted remotely and in operative communication with the event detection and reporting system 100 such as a forward facing camera 122 to record images of the roadway ahead of the vehicle. Such cameras may, for instance, indicate undesirable proximity to objects, the roadway verge, etc.

In some embodiments, driver related data can be collected directly using the driver facing camera 122, such driver related data including head position, eye gaze, hand position, postural attitude and location, or the like, within the vehicle. In addition, driver identity and/or presence can be determined based on facial recognition technology, body/posture template matching, and/or any other technology or methodology for making such determinations by analyzing video data.

In operation, the driver facing camera 122 may video data of the captured image area. The video data may be captured on a continuous basis, or in response to a detected event. Such data may comprise a sequence of video frames with separate but associated sensor data that has been collected from one or more on-vehicle sensors or devices, as detailed herein.

The event detection and reporting system 100 may also include a transmitter/receiver (transceiver) module 170 such as, for example, a radio frequency (RF) transmitter including one or more antennas for wireless communication of data and control signals, including control requests, event-based data, performance-based data, vehicle configuration/condition data, or the like, between the vehicle and one or more remote locations/devices, such as, for example, backend servers, dispatch center computers, and mobile devices, having a corresponding receiver and antenna. The transmitter/receiver (transceiver) module 170 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 130 may be operative to select and combine signals from the sensor systems into event-based data and/or performance-based data representative of higher level vehicle and/or driver related data. For example, data from the multi-axis acceleration sensors 112 may be combined with the data from the steering angle sensor 113 to determine excessive curve speed event data. Other hybrid data relatable to the vehicle and/or driver and obtainable from combining one or more selected raw data items from the sensors includes, for example and without limitation, excessive braking event data, excessive curve speed event data, lane departure warning event data, excessive lane departure event data, lane change without turn signal event data, lane change without mirror usage data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, following distance event data, fuel consumption event data, ACC usage event data, and late speed adaptation (such as that given by signage or exiting). Still other hybrid data relatable to the vehicle and/or driver and obtainable from combining one or more selected raw data items from the sensors includes, for example and without limitation, driver out of position event data, passenger out of position event data, driver distracted event data, driver drowsy event data, driver hand(s) not on wheel event data, passenger detected event data, wrong driver event data, seatbelt not fastened event data, driver cellphone use event data, distracting passenger event data, mirror non-use event data, unsatisfactory equipment use event, driver smoking event data, passenger smoking event data, insufficient event response event data, insufficient forward attention event data. The aforementioned events are illustrative of the wide range of events that can be monitored for and detected by the event detection and reporting system 100, and should not be understood as limiting in any way.

The event detection and reporting system 100 may further include a bus or other communication mechanism for communicating information, coupled with the processor 130 for processing information. The system may also include a main memory 150, such as random access memory (RAM) or other dynamic storage device for storing instructions and/or loaded portions of a trained neural network to be executed by the processor 130, as well as a read only memory (ROM) or other static storage device for storing other static information and instructions for the processor 130. Other storage devices may also suitably be provided for storing information and instructions as necessary or desired.

In at least some embodiments, the event detection and reporting system 100 of FIG. 1 is configured to execute one or more software systems or modules that perform or otherwise cause the performance of one or more features and aspects described herein. Computer executable instructions may therefore be read into the main memory 150 from another computer-readable medium, such as another storage device, or via the transceiver 170. Execution of the instructions contained in main memory 150 may cause the processor 130 to perform one or more of the process steps described herein. In some embodiments, hard-wired circuitry may be used in place of or in combination with software instructions to implement the invention. Thus, implementations of the example embodiments are not limited to any specific combination of hardware circuitry and software.

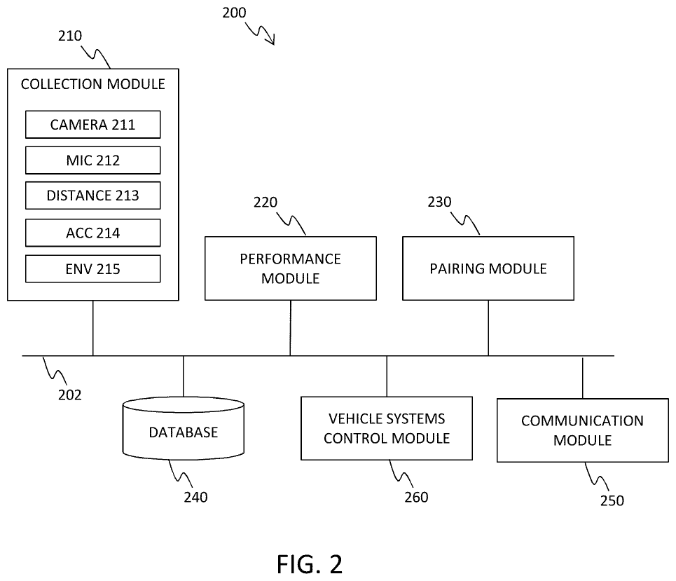

FIG. 2 is a schematic block diagram depicting an exemplary system architecture 200 for controlling a vehicle based on the evaluation of individual and multi-person driving teams, in accordance with at least one embodiment. The system architecture may be implemented via the event detection and reporting system of FIG. 1, and may include one or more functional modules. The functional modules may be embodied by one or more processors, alone or in combination with other system components, executing one or more software applications so as to configure the processors to implement the described functions, or otherwise cause the implementation of such functions via other system components.

The system architecture may include one or more sensors and/or sensor systems (“sensors”) 210 configured to detect at least driving performance during the driving excursion, and generate performance-based data therefrom characterizing at least the detected driving performance.

The sensors 210 may include sensors, devices or systems 110 discussed with reference to FIG. 1, including but not limited to, one or more cameras 211, microphones 212, distance sensors 213, acceleration sensors 214 and environmental sensors 215. The sensors 210 may further include corresponding sensor modules for configuring the sensors for the functions described herein.

The one or more cameras 211 may be trained on the interior of the cab of the commercial vehicle, such that the cameras 211 capture views of the interior cab, and to generate video sensor data from which at least performance-based data can be generated. Such views may include views of the driver seat area, areas corresponding to driver controls (e.g., steering wheel area, gear shifter area, etc.), and non-driving passenger areas (e.g., the passenger seat area, bunk area, etc.).

The one or more microphones 212 or other audio recording devices may be operable to capture audio of the interior cab, and to generate audio sensor data from which at least performance-based data can be generated. Such audio may include captured speech of the driver and/or passenger. In at least one embodiment, the microphones 212 may be configured to detect one or more speech or other audio parameters, such as content, volume, pitch, frequency, harmonic structure, direction, etc., in lieu of the entire audio.

The one or more distance sensors 213 may be configured to sense the distance of the vehicle from a surrounding vehicle (i.e., another vehicle in the surroundings of the vehicle), or other object (e.g., lane markers, etc.), and to generate distance sensor data from which at least performance-based data can be generated. Such detected distances may include, but are not limited to, the forward distance between the vehicle and another vehicle in front of the vehicle (i.e., the headway or following distance), the lateral distance between the vehicle and another vehicle to the side of the vehicle, the lateral distance from the vehicle to lane markings, the backwards distance between the vehicle and another vehicle behind the vehicle, etc. The distance sensors 213 can be optical, lidar, radar or other technology based, without departing from the scope of the invention.

The one or more acceleration sensors 214 (and/or speed sensors) may be configured to sense lateral and/or longitudinal accelerations of the vehicle, and to generate acceleration sensor data from which at least performance-based data can be generated. Such acceleration sensors 214 may include one or more multi-axis accelerometers, including accelerometers in the trailer.

The one or more environmental sensors 215 may be configured to detect environmental circumstances related to the driving excursion, and to generate environmental sensor data from which at least performance-based data can be generated. Such circumstances can include, for example, the weather, temperature, road conditions, light intensity, time of day, traffic conditions, etc. In at least some embodiments, environmental data may alternatively or additionally be transmitted to the system via the transceiver in lieu of, or in addition to, the environmental sensor data.

The system architecture may further include a performance module 220, which may be embodied in processor 130 or may be embodied in one or more processors at the one or more remote locations/devices (e.g., remote server system). The performance module 220 may be configured to analyze the performance-based data so as to determine one or more performance events and/or performance propensities therefrom. The performance events can define a particular type of driver and/or vehicle related event, such that, in similar fashion, vehicle systems may be controlled in response to the detection of one or more performance events, as discussed herein. The performance propensities may characterize the driver and/or passenger behavior with regard to propensities towards such performance events.

Such characterizations may include generating a driving team compatibility score based on an analysis of the performance propensities of the driving team. The compatibility score may correspond to the performance propensities of one or more events corresponding to respective monitored driving behavior/performance. Where the monitored behavior/performance is undesired, a higher propensity towards the behavior/performance may correspond to a lower compatibility score, and vice versa. Additionally, or alternatively, performance events and/or propensities can be used to characterize driving teams with regard to driving performance, particularly performance costs (i.e., the costs/benefits of driving team composition on performance), as also discussed herein.

Example performance events include, but are not limited to, performance affecting events indicating behavior likely to affect driving performance, such as distracting behavior (e.g., passenger talking to driver, etc.), unauthorized behavior (e.g., unauthorized passenger present), etc., and affected performance events likely reflecting effects on performance (e.g., reduced or increased headway, smoother or less smooth driving, etc.).

The system architecture may also include a pairing module 230, which may be embodied in processor 130 or may be embodied in one or more processors at the one or more remote locations/devices (e.g., remote server system). The pairing module 230 may be configured to analyze one or more performance events and/or compatibility scores so as to recommend driving team compositions based on the effects of such composition on driving performance. Driving team recommendations may be made that account for the performance effects that performance affecting behaviors and/or circumstances have on specific driving teams. Such driving team recommendations may include for example, team compositions pairing according to temperament (e.g., anodyne or non-distracting passengers with not-easily-distracted drivers, etc.), pairing according to driving excursion circumstances (e.g., urban drivers with open highway drivers, daytime drivers with nighttime drivers, etc.), or according to any other propensities and/or performances desired. Other analysis may be also be performed to determine recommendations for driving team compositions. Such driving team recommendations may be utilized to generate work schedules for drivers and passengers.

The system architecture 200 may also include a database 240 and a communications module 250, each communicatively coupled to each other and to the sensors and performance module via a system bus 202. The database 240 may be configured to store and otherwise manage data and information, including for example, performance-based data, performance events, performance propensities, environmental circumstances, and relationships therebetween, in furtherance of the functions described herein. The communications module 250 may be configured to send/receive data and information to/from the remote location, in furtherance of the functions described herein.

The system architecture 200 may still further include a vehicle-systems control module 260, also communicatively coupled to the system bus 202, and which may be configured to control one or vehicle systems in response to the detected performance events and/or driving team composition recommendations. In general, the detected performance events and/or driving team compositions may be relied on by the vehicle-systems control module in controlling one or more vehicle systems. Such control may occur directly in response to detected performance events and/or driving team compositions communicated in-vehicle among the architecture components. Additionally, or alternatively, such control may occur indirectly, in response to control signals received from the remote location/device, which may generate the control signals in response to receiving one or more transmissions of performance-based data, performance events, performance propensities and/or the detected events and/or driving team compositions from the event monitoring and reporting system 100.

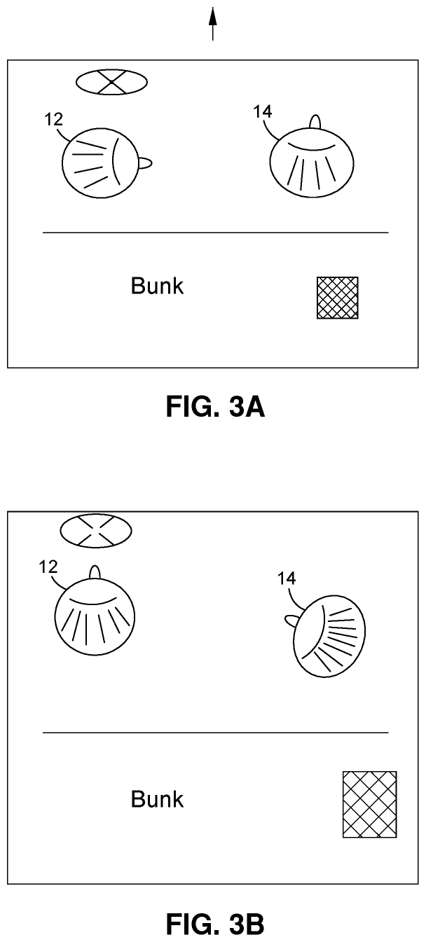

Exemplary performance events and the detections and analyses thereof will now be discussed with reference to FIGS. 3-8. It will be understood that the example event detections and analyses provided herein are illustrative of principles that can be applied to other event detections and analyses—and that such principles are not limited to the described examples.

As discussed herein, various performance events may be detected via analysis of sensor collected performance-based data characterizing driver and/or passenger behavior to-be detected. These performance events can include performance affecting events (i.e., behavior that affects driving performance) and/or affected performance events (i.e., events indicating driving behavior is affected).

In general, the performance events can be detected via comparison of the performance-based data to one or more thresholds or reference models. Where the performance-based data exceeds the threshold, or matches the model, the correspondingly defined performance event is determined to be detected.

The performance-based data thresholds can include value thresholds, duration thresholds (i.e., duration for which the value threshold must be exceeded, or sufficiently well model matched) and/or rate thresholds (i.e., rate at which the value threshold must be exceeded, or model matched, per rate period). The thresholds and/or models, as well as the performance-based events they implicate, can be empirically determined, or otherwise theorized, and stored in the database for use by the performance module.

An exemplary performance event may be a diverted gaze event, via which the diverted gaze may be taken as a proxy for driver inattention to the driving task. The diverted gaze event may be detected from head pose data characterizing driver and/or passenger gazes. The head pose data may be generated from the captured video data using one or more image analysis techniques, e.g., image recognition. Example gaze characterizations can include but are not limited to particular angular rotations (e.g., yaw, pitch, roll) of the head with respect to a reference position (e.g., facing forward), which may indicate the direction of the driver and/or passenger's gaze. Facial normal vectors, including the intersections of driver and passenger facial normal vectors, may be utilized to determine such gaze orientations and/or intersections thereof. The degree of intersection may be measured via angles between such vectors.

The diverted gaze event can be determined based on the head pose data exceeding one or more diverted gaze thresholds, or matching one or more reference models, which can be set so as to detect to-be determined performance affecting behaviors (e.g., diverted gaze). For example, the degree of angular rotations may more or less strongly indicate certain performance affecting behaviors, such as for example, not looking at the road, engaging in conversation, or otherwise having his/her gaze distracted or diverted from the road. The diverted gaze thresholds (e.g., a rotation threshold) and/or reference models may be set so as to detect such behaviors.

FIG. 3A shows, for example, the head yaw of the driver 12 is 90 degrees from front, which can be detected as exceeding a +/−80 degree rotation threshold. As another example, FIG. 3B shows the head yaw of the passenger 14 is −90 degrees from front, which can be detected as exceeding the same threshold. In each case, the behavior indicated by the detected diverted gaze event is the driver and/or passenger turning to look at the other. The illustrated yaw ranges and head poses are provided for example only. Other thresholds may be set so as to identify other performance affecting behaviors.

The diverted gaze event can also be determined based on the head pose data exceeding rotation thresholds for longer/shorter than one or more durations (i.e., gaze held threshold), which also can be set so as to detect to-be determined performance affecting behaviors (e.g., diverted gaze). Frequent sidelong glancing may, for example, be detected as recurring, brief, directional gaze diversion. As another example, more prolonged gazing by the driver downward may more strongly indicate performance affecting behaviors, such as for example, using a smart phone or other device positioned in the driver's lap—whereas more prolonged gazing of the driver and passenger towards each other may more strongly indicate an intent conversation. Such gaze held thresholds may be set so as to allow for de minimis behaviors, e.g., brief sideways glances to check a side mirror, etc., that might otherwise trigger the diverted gaze event if held for longer than the gaze held threshold.

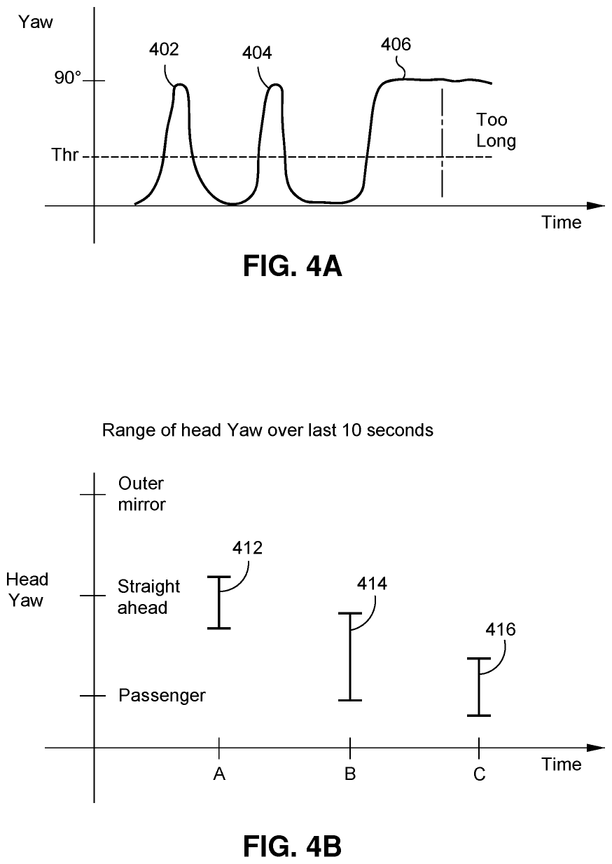

FIG. 4A shows, for example, a time history of driver head pose data characterizing the head yaw over time. The 90 degree mark may correspond to a full turn towards the passenger. The threshold mark (Thr) may indicate the rotation threshold past which the driver's gaze is considered to be diverted. The time periods for which the yaw exceeds the rotation threshold can be calculated and compared to the gaze held thresholds, so as to determine whether the diverted gaze event has occurred. For example, curves 402 and 404 may not trigger the diverted gaze event, due to not lasting long enough to exceed the gaze held threshold, whereas curve 406 may trigger the diverted gaze event, due to lasting sufficiently long enough to exceed the gaze held threshold. Frequent sidelong glancing may be detected via accumulation of head pose in a certain direction.

The diverted gaze event can also be determined based on the head pose data exceeding rotation thresholds at a rate that is more/less than a gaze rate threshold, which can also be set so as to detect to-be determined performance affecting behaviors (e.g., diverted gaze). The gaze rate threshold can define a number of times the diverted gaze threshold needs to be exceeded per gaze rate period in order for the gaze rate threshold to be exceeded. For example, more reoccurring gazes by the driver downward within a shorter period may more strongly indicate performance affecting behaviors, such as for example, using a smart phone or other device positioned in the driver's lap, a display showing a video, and so on. Such gaze rate thresholds may be set so as to allow for de minimis behaviors, e.g., one or two glances upwards to check the rearview mirror, etc., that might otherwise trigger the diverted gaze event if exceeding the gaze rate threshold.

Returning to FIG. 4A, for example, the rate at which the head yaw exceeds the rotation threshold can be calculated and compared to the gaze rate thresholds, so as to determine whether the diverted gaze event has occurred. For example, curve 402 alone may not trigger the diverted gaze event, whereas curves 402 and 404 together may trigger the diverted gaze event, due to gaze rate exceeding the gaze rate threshold by occurring close in time.

The diverted gaze event can, additionally or alternatively, be determined via statistical analysis of the data.

FIG. 4B shows, for example, the detected driver head yaw at time intervals A, B and C, where the head pose data (e.g., yaw values) has been collected for each of the time intervals (e.g., every 2.5 seconds). The head pose data ranges 412, 414, 416 for each time interval may be characterized by its minimum and maximum values, or by other statistical methods (e.g., percentile bounds such as the mean+/−2 standard deviations). At time interval A, the driver is looking straight ahead; at time interval B, the driver is partially turning towards the passenger; and at time interval C, the driver is fully turned towards the passenger. It will be understood that, for example, in time interval B, the driver may be, for some percentage of the time still looking straight ahead, as shown in the figure. Moreover, the head pose data can, alternatively, be for the passenger or the driver and passenger combined. The diverted gaze event can thus be determined from the detected situation that the driver, during intervals A and B, has turned away from the road for more than the threshold duration (e.g., 5 seconds) needed to trigger the diverted gaze event.

Another exemplary performance event may be a hand activity event, which may be detected from hand activity data characterizing driver and/or hand activity. The hand activity data may be generated from the captured video data using one or more image analysis techniques, e.g. image recognition. Example hand activity characterizations can include but are not limited to particular distances of one or more hands from reference locations (e.g., vehicle controls, structures and other landmarks), which may indicate such hand activity as, for example, vehicle control activity (e.g., operating the steering wheel, gearshift, etc.), rest activity (e.g., resting on an armrest, lap, etc.), and gesture activity (e.g., waving, etc.).

The hand activity event can be determined based on the hand activity data (e.g., distance from landmarks) exceeding one or more hand activity thresholds, or matching one or more reference models, which can be set so as to detect to-be determined performance affecting behaviors (e.g., hands-off the controls, hands gesturing, etc.). For example, the distance of the hands from landmarks (e.g., the steering wheel, the armrests, etc.) may more or less strongly indicate certain performance affecting behaviors, such as for example, hands-off the controls and gesturing to the side, or that the hands are otherwise in positions affecting driving performance. The hand activity thresholds (e.g., distance thresholds) and/or reference models may be set so as to detect such behaviors Similar to the diverted gaze event detection, the hand activity thresholds may also include corresponding duration and rate thresholds.

For example, hand activity data may characterize the areas of the camera view that hand centroids cover over a time interval, particularly with regard to distance from the steering wheel. The hand activity data range over the time interval may be characterized by its minimum and maximum values, or by other statistical methods (e.g., percentile bounds such as the mean+/−2 standard deviations). A larger hand activity data range over a short time interval may correspond, for example, to hands that are further from the steering wheel and are exhibiting large amplitudes and/or high frequency motions associated with intense gesturing.

A further exemplary performance event may be a speech activity event, which may be detected from speech activity data characterizing driver and/or passenger speech activity. The speech activity data may be generated from the captured video data and/or audio data, using one or more image and/or audio analysis techniques, e.g. image recognition, speech recognition, etc. Example speech activity characterizations can include but are not limited to particular facial landmark (e.g., mouth corners, etc.) positions, and speech parameters (e.g., volume, pitch, frequency, and content), which may indicate the driver and/or passenger speech activity as, for example, speaking, shouting, arguing, singing, or any other speech activity.

The speech activity event can be determined based on the speech activity data exceeding one or more speech activity thresholds, or matching one or more reference models, which can be set so as to detect to-be determined performance affecting behaviors (e.g., conversing, arguing, etc.). For example, the degree to which the mouth is opening and the volume of speech volume may more or less strongly indicate certain performance affecting behaviors, such as arguing or otherwise engaging in detectable speech activity. The speech activity thresholds (e.g., mouth shape thresholds and volume thresholds) and/or reference models may be set so as to detect such behaviors. Similar to the diverted gaze event detection, the hand activity thresholds may also include corresponding duration and rate thresholds.

In some embodiments, the audio data may be filtered or otherwise processed so as to remove or otherwise reduce background noise attributable to non-speech (e.g., engine noise). Such filtering may be based on data from other sensors, such that the filtering may better account for noise by considering detected vehicle parameters, such as for example, detected engine RPM, vehicle gear, throttle position, etc. and by notch-filtering out formant and harmonic frequencies coming from the drive train and/or other vehicle components. Notch filtering rules may be learned when the driver is alone and not speaking. Furthermore, due to frequency proportionally scaling with speed and rpm, such values may be read/set from the current vehicle drive train parameters.

Moreover, the capturing of facial landmarks by the camera during speech activity may be improved by placing the camera on the central axis of the vehicle, angled towards the driver seat area. This provides a higher angular resolution for the driver seat area, and provides for improved capturing of the driver's face/mouth when he/she looks toward and beyond the central axis of the vehicle from the driver seat area, as would tend to occur during conversations with the passenger.

Another exemplary performance event may be a headway event, which may be detected from forward distance data characterizing the headway between the vehicle and an object (e.g., another vehicle) in front of the vehicle. The headway event may be generated from the forward distance sensor data, using known techniques in the art. Example headway characterizations include, but are not limited to, distance-gap (i.e., meters, etc., from impact) and time-gap (e.g., seconds, etc. from impact or a speed-dependent time headway), which may indicate the headway between the vehicle and the front object as, for example, following too close/far, increasing/decreasing following distance, or any other headway activity.

The headway activity event can be determined based on the forward distance data exceeding one or more distance thresholds, or matching one or more reference models, which can be set so as to detect to-be determined performance affecting behaviors (e.g., following too close, increasing following distance, etc.). For example, the degree to which the following distance is increased/decreased/varies may more or less strongly indicate certain performance affecting behaviors, such as the driver being distracted. Desirable headway may be determined as a combination of detected events, e.g., meeting the distance threshold with only slight speed variations, which is a fuel-efficient behavior.

The distance thresholds and/or reference models can also be set to detect to-be determined performance behavior effects (e.g., following too close, increasing following distance, etc.), which may similarly characterize the effects of performance affecting behaviors or circumstances. For example, the degree to which the following distance is increased/decreased/varies during a driver-passenger conversation may more or less strongly indicate a propensity for such conversations to affect headway.

Accordingly, the headway event may be one or more of: a performance affecting event and an affected performance event, in accordance with various set thresholds and/or models being set to detect the desired behaviors and/or effects. Moreover, similar to other event detections, the thresholds may also include corresponding duration and rate thresholds.

Another exemplary performance event may be a smoothness event, which may be detected from lateral/longitudinal acceleration data characterizing the smoothness of the driving. The smoothness event may be generated from the lateral/longitudinal acceleration sensor or speed data, using known techniques in the art. Example smoothness characterizations include, but are not limited to, braking, acceleration, swerving, etc., which may indicate driving smoothness activity as, for example, sharp braking, sharp acceleration, sharp course corrections, or any other driving smoothness activity. Average absolute value of acceleration may be used as a metric for smoothness.

The smoothness event can be determined based on the acceleration data exceeding one or more smoothness thresholds, or matching one or more reference models, which can be set so as to detect to-be determined performance affecting behaviors (e.g., sharp braking, sharp acceleration, sharp course corrections, etc.). For example, the magnitude of lateral/longitudinal accelerations may more or less strongly indicate certain performance affecting behaviors, such as the driver being distracted, due to a delayed or increased anticipation of necessary speed/course corrections. An event-free smoothness measure may be the average absolute value of acceleration, either with or without direction (e.g. longitudinally, laterally, or their vector combination). The smoothness measure may indicate that a particular passenger causes a more/less smooth behavior with a particular driver. Such event-free metrics are useful for characterizing driver behavior and may replace or complement traditional events of event monitoring systems.

The smoothness thresholds and/or reference models can also be set to detect to-be determined performance behavior effects (e.g., sharp braking, sharp acceleration, sharp course corrections, etc.), which may similarly characterize the effects of performance affecting behaviors or circumstances. For example, the magnitude of lateral/longitudinal accelerations may more or less strongly indicate a propensity for such conversations to affect driving smoothness.

Accordingly, the smoothness event may be one or more of: a performance affecting event and an affected performance event, in accordance with various set thresholds and/or models being set to detect the desired behaviors and/or effects. Moreover, similar to other event detections, the thresholds may also include corresponding duration and rate thresholds.

The performance events can further include compound performance events, which may be detected from performance-based data characterizing driver and/or passenger behaviors that implicate a plurality of performance indicators. Such compound performance events may include, for example, bunk checking activity, not using the passenger side mirror, and any other activity that can be characterized via a plurality of performance indicators.

An example of a compound performance event may be an unseen passenger event, which may be detected from one or more of: driver head pose data, speech activity data and hand activity data, characterizing unseen passenger activity. In particular, passenger presence can be inferred in the absences of captured video of the passenger via the analysis of the referenced performance indicators to determine whether gaze activity, hand activity and/or speech activity characterize an unseen passenger. Example characterizations for unseen passenger activity include, but are not limited to: the driver conversing or otherwise interacting as though with another person, which may indicate that there is an unseen passenger.

The unseen passenger event can be determined based on the driver head pose data, speech activity data and hand activity data exceeding one or more respective thresholds, or matching one or more reference models, which can be set so as to detect the to-be determined unseen passenger event. This can be done in similar manner as discussed above with respect to those performance indicators.

Another exemplary compound performance event may be a bunk checking event, which may be detected from one or more of: driver head pose data and hand activity data characterizing driver bunk checking activity. Example bunk checking characterizations can include but are not limited to the driver diverting his/her gaze to the bunk area with one hand on the wheel and the other hand extended for turning leverage, which may indicate the driver is checking the bunk area.

The bunk checking event can be determined based on the driver head pose data and hand activity data exceeding one or more respective thresholds, or matching one or more reference models, which can be set so as to detect the to-be determined bunk checking. This can be done in similar manner as discussed above with respect to those performance indicators.

Accordingly, any number of other performance events may be defined as functions of any combination of one or more performance indicators, considering respective performance-based data, and characterizing any number of behaviors that tend to distract from driving and thereby affect driving performance.

For example, a dangerous argument event may be defined by diverted gaze, hand activity and speech so as to be detected when the respective performance-based data indicates the driver and passenger are facing towards each other for extended periods of time while gesturing emphatically at each other, yelling loudly and making angry faces.

As another example, an object exchange event can also be defined by diverted gaze, speech and hand activity so as to be detected when the respective performance-based data indicates that the driver and passenger are briefly facing towards each other, each with one hand extended towards the other, preceded by a short conversation. The circumstance of driver and passenger turning towards each other can be detected via comparison of the facial normal vectors (e.g., substantially converging vectors indicating the circumstance).

Moreover, compound performance events can be defined to more particularly detect increasingly complex behaviors without departing from the scope of the invention. Such compound performance events may be based on the detection of constituent performance events of varying gradation and complexity. For example, performance events may be defined for a generic speech activity characterizing the driver as speaking, as well as for specific speech activities, such as for example, the driver is crying, yelling, whispering, mumbling, slurring, etc. This type of gradation in defining performance events can be similarly applied to other performance indicators so as to detect complex behaviors. For example, biometric data can be analyzed to determine wide ranges of occupant emotional states, based on, for example, detected heartrates, respiration rates, etc., alone or in combination with other captured data (e.g., gestures, speech characteristics, etc.)

In at least one embodiment, performance events may be determined based on the performance-based data diverging from characterizations of baseline behaviors. The baseline behaviors may be, for example, ideal or normal behaviors defined with regard to one or more performance indicators. The performance events can be determined based on performance-based data diverging from baseline behavior by one or more thresholds, or so as to match one or more reference models. In the case of event-free metrics, baseline may be, e.g. the driver's acceleration magnitude distribution, and the divergent behavior then compared with this. The disparity between e.g. the values in binned histograms of the distributions may serve for comparison.

For example, referring back to the diverted gaze event discussion with respect to FIGS. 3-4, the diverted gaze event can be determined based on the head pose data diverting from a gaze baseline by one or more rotation thresholds, or to match one or more reference models, which can be set so as to detect the diverted gaze. For example, the gaze baseline may be set as 0 degree head yaw (i.e., eyes-forward), whereas the rotation threshold may be set at +/−80 degrees. The diverted gaze event can thus be detected via determining whether the detected head pose data diverges from the gaze baseline by more than the rotation threshold. Time may also be considered in measuring divergence, e.g. by using the percentage time spent over the rotation threshold over an interval (which may be, e.g., 15 seconds)

In this manner, driving behavior can be quantified in terms of diminished and/or improved performance with respect various events and/or indicators (e.g., lane position, following distance, driving smoothness, distracted gazes, conversations, miles between events, etc.). Thus, one or more performance costs, reflecting the effects of detected events on driving performance, may be determined.

In at least some embodiments, one or more performance events may be analyzed to determine performance propensities, which may characterize the driver and/or passenger behavior with regard to propensities towards such performance events. Example propensity characterizations can include, but are not limited to: number (e.g., quantity of event detection, etc.), frequency (e.g., rate of event detection, e.g.), associated time/distance (e.g., percentage of driving excursion total time/distance event occupied, etc.), average, and/or any other characterization that may indicate propensities towards one or more performance events. Event-free characterizations may also be used to characterize performance.

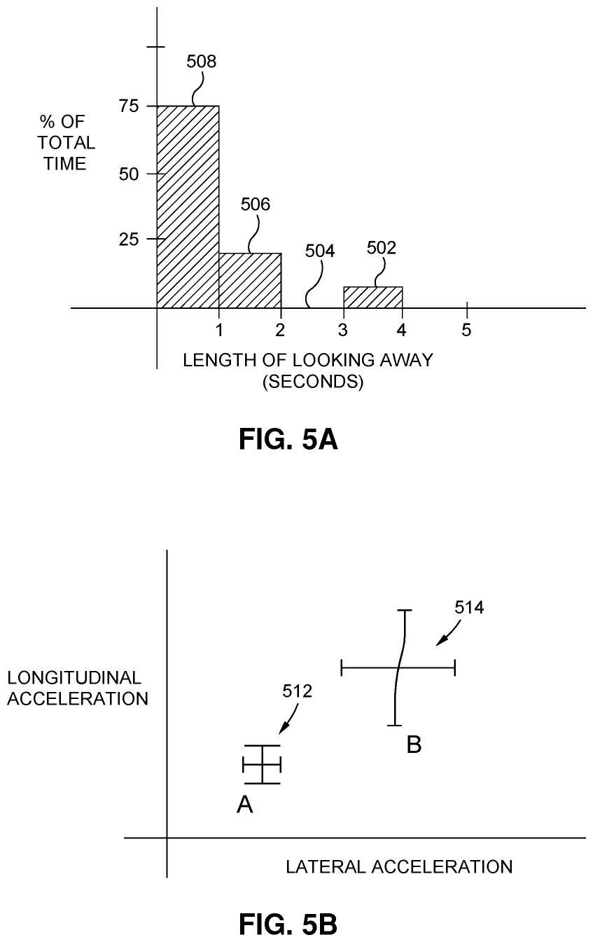

FIG. 5A illustrates, via histogram, an exemplary statistical analysis for determining a diverted gaze propensity. As can be seen, a diverted gaze event (e.g., driver looking at passenger) is detected multiple times over a monitoring interval (e.g., during one or more driving excursions, or portions thereof). For 5% of the monitoring interval, the diverted gaze event is detected as lasting between 3-4 seconds (502); for 0% of the monitoring interval, the diverted gaze event is detected as lasting between 2-3 seconds (504); for 10% of the monitoring interval, the diverted gaze event is detected as lasting between 1-2 seconds (506); and for 75% of the monitoring interval, the diverted gaze event is detected as lasting between 0-1 second (508). The diverted gaze propensities for these behaviors may therefore be 0.05, 0.00, 0.10 and 0.75, respectively.

As another example, performance propensities may be determined via a masked histogram approach. The masked histogram may require satisfaction of one or more conditions, e.g., the detection of one or more other performance events, in order to consider the detection of the performance event in the histogram. For example, it may be that a headway event (e.g., following distance between 1.5 to 2.0 seconds) is only considered in determining the propensity for such behavior when a distracted gaze event (e.g., driver looking at passenger) is also detected at the same or close in time with the headway event. In this manner, the system can consider only relevant driving behaviors and/or circumstances (including environmental circumstances) in determining the performance propensities of the driving team.

In at least some embodiments, propensity data characterizing the determined performance propensities may be utilized as a type of event-based data. Thus, where the propensity data (e.g., number of diverted gaze events detected) exceeds one or more propensity thresholds, or matches reference models, a performance propensity event may be determined. For instance, baseline performance may have the driver's mean gaze yaw be zero degrees, with a dispersion (e.g. standard deviation) of 12 degrees. A certain passenger (perhaps interesting, perhaps irritating, perhaps talkative, etc.) may change this same driver's mean gaze yaw value to 10 degrees right (i.e. toward the passenger) and the dispersion to 25 degrees. These values may be compared with a statistical distance, e.g. the Mahanalobis distance. Alternatively, the driver may incur more lane departure events per mile or per hour with this same passenger (in the case where event-based statistics are chosen) than without this person.

Such propensity thresholds can be set, for example, based on one or more policies or desired behaviors. The driver propensity data can be compared to these thresholds to determine compliance. For example, fleet policy may require the average or median time looking away to be less than some value, or require that the total percentage of time spent looking away for more than 1 second be less than 10%, or that there be no episodes of looking away of duration greater than some maximum.

A driving team compatibility score may also be determined by the performance module based on an analysis of the performance propensities of the driving team. The compatibility score may correspond to the performance propensities of one or more events corresponding to respective monitored driving behavior/performance. Where the monitored behavior/performance is undesired, a higher propensity towards the behavior/performance may correspond to a lower compatibility score, and vice versa. One or more analysis techniques, without limitation, may be utilized to determine the compatibility score.

For example, the compatibility score for the driving team may correspond to the propensity towards a distracted gaze and conversation event characterized by the detection of the driver looking towards the passenger for some minimum period of time at some rate while a driver-passenger conversation is occurring. The compatibility score for the driving team may correspond to the number of times the distracted gaze and conversation event occurs during the driving excursion for the driving team.

Additionally, or alternatively, the compatibility score can be determined as the divergence from one or more baseline compatibility scores for the corresponding indicators. The baseline compatibility scores may be, for example, the compatibility scores of the driver-only driving team, or for any other driving team to which comparison is desired. Moreover, the baseline compatibility scores may be, for example, defined with respect to actual or theoretical (e.g. model) behaviors.

FIG. 5B illustrates an exemplary mean/dispersion approach to analyzing performance-based event data to determine performance propensities. The illustrated graph reflects the mean and dispersion values 512, 514 for longitudinal and lateral accelerations for the driver during comparable driving excursions with passenger A and passenger B, respectively. The baseline driver-alone reference may be taken as at the origin, and with a unit (normalized) standard deviation. The mean and dispersion may be used to derive a Z-score (or otherwise, the median and interquartile range may be taken) for the deviation from the baseline behavior for the driver. The increase/decrease in performance relative to the baseline may then be characterized by the Z-score. In the figure, it can be seen—considering only the mean values—that passenger B associates with the driver having both higher lateral and longitudinal accelerations, i.e. passenger B is a worse copilot/companion, than passenger A. If dispersion is also considered, a more complicated statistical distance measure must be used. In that case, passenger B, though having a mean (at the intersection of the two bars) further from the origin, may be closer in a statistical sense, since the larger standard deviation reduces the effective distance to the origin.

Returning to the prior example, the baseline compatibility score may be the driver-only score for the number of miles between distracted gaze and conversation events, which in that case is likely zero due to the absence of the passenger in the driver-only context. The compatibility score for the driving team of driver and passenger may therefore be determined as the divergence from zero. ‘Zero’ may be the driver alone or a desired distribution or value set, that is, even the driver alone, though very good, is not perfect.

The driving team compatibility scores may be determined for each driving team under consideration. In this manner, the compatibility of various driving teams can be quantified in terms of diminished and/or improved performance with respect various behaviors/performances (e.g., lane position, following distance, driving smoothness, distracted gazes, conversations, miles between events, etc.). Thus, one or more performance costs, reflecting the effects of team composition on driving performance, may be determined.

In some embodiments, the compatibility score may be determined as a function of respective propensities towards a plurality of behaviors/performances, where the function may combine the respective propensities in to the single compatibility score for the driving team.

The combination may be according to a weighted sum, vector norm magnitude, or any other functional relationship that appropriately combines the respective propensities. Where the compatibility score is a weighted sum of respective propensities, the respective propensities may be weighted according to the severity of their respective behaviors/performances. The severity of each behavior/performance may, in turn, correspond to the performance costs associated with such behaviors.

For example, the propensity for a prolonged argument may be more heavily weighted than the propensity for a brief conversation, with the weighting determined based on the performance costs to one or more indicators (e.g., headway distance, etc.) for the driving team. In this manner, the compatibility score may be determined based on propensities that are weighted differently for some driving teams than for others, such as, for example, where one driving team is more resistant to the performance effects of certain performance affecting events than another. The conditions of the roadway may be also considered. For example, a winding mountain road is best driven with good, low deviation, lateral control, and the lateral control performance indicator may therefore be more heavily weighted under such environmental circumstances.

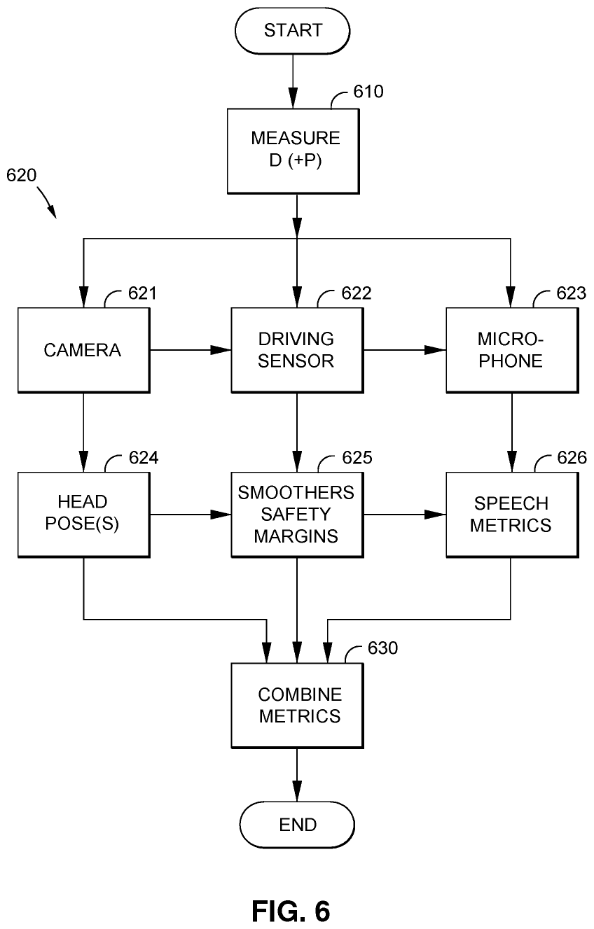

FIG. 6 illustrates an exemplary method for determining the compatibility score for an exemplary driving team, according to at least one embodiment. It will be understood that the method can be performed with respect to any driving team, including the driver-only driving team.

In step 610, the driving team composition can be determined. The determination of the driving team composition may be via any known methods. In some embodiments, the driving team composition may be determined via captured event-based data. For example, the driving team composition can be determined from vehicle telematics system log-in data, which may identify the driver and/or passenger, or from captured video data subjected to facial recognition to identify the driver and/or passenger, or by any other techniques for identifying the driving team.

In step 620, the performance-based data may be collected for the driving team—and may be stored in association with the driving team composition data identifying the driving team. The performance-based data can be collected for one or more of the performance indicators, or combinations thereof, in accordance with the behaviors, performances and/or effects whose monitoring is desired.

For example, as shown, the camera can be operated to collect head pose data, in step 621; the driving sensors (e.g., acceleration, speed, following distance, lane position, etc. sensors) can be operated to collect driving safety and smoothness data, in step 622; and the microphone can be operated to collect audio data, in step 623. Such performance based-data can thereafter be analyzed to determine various performance events and/or propensities, in steps 624, 625 and 626, respectively.

In step 630, the compatibility score may be determined via combining the performance events and/or propensities. The combination may be according to a weighted sum, by reaching a certain combination of behaviors/performances (e.g., highly agitated speech and hand gesturing, etc.), by the single or top-n maximum measures referenced to a scale, or by any other methodologies for characterizing driving team compatibility from detected performance events and/or propensities.

The resulting compatibility score may be a single number reflecting the compatibility of the driving team, which can be used to determine which driving team compositions are beneficial/detrimental to the aspects of driving performance considered in generating the compatibility score. In some embodiments, the environmental conditions may be considered in generating the compatibility score, such that it may be determined that certain driving team compositions are desirable/undesirable under certain circumstances. For example, it may be determined that one driving team is excellent at night driving excursions, but not as good during daytime excursions. Who is driving at nighttime or during daytime may therefore be considered for team performance.

In at least one embodiment, the performance-based data, the performance events, the performance propensities and/or the compatibility scores may be stored in the database for analysis thereon. In particular, such data can be used to determine driving team recommendations and/or to control one or more vehicle functions based on driving team performance.

If, for example, a given passenger is determined to disturb multiple drivers, it may be recommended that this passenger drive alone. In some embodiments, the average or median disturbance that a passenger causes to multiple drivers (e.g., the respective performance costs) may be used as a metric for recommending that the passenger drive alone.

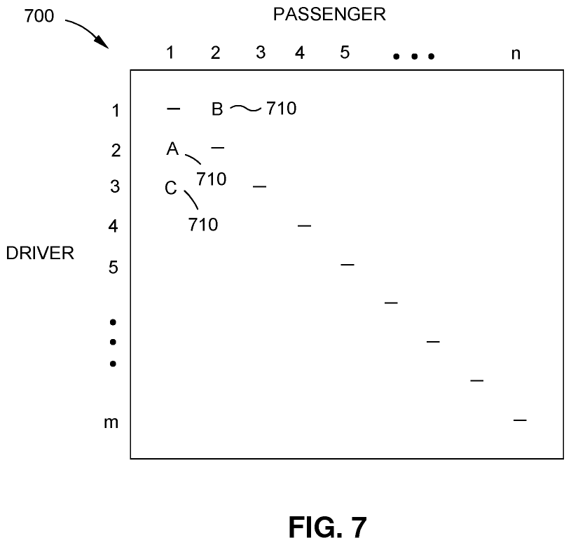

FIG. 7 illustrates an exemplary performance table 700, which may be stored in the database, characterizing driving team performance across a plurality of driving team compositions, with various drivers represented by number identifier along the vertical axis and passengers along the horizontal axis. The table entries 710 characterize the performance of each driving team, with the diagonal characterizing the performance of the driver driving alone. Performance characterization may account for ancillary factors such as day or night driving, urban or ex-urban road or traffic conditions, etc. For example, a driver may be characterized, alone while driving during the day, and then also characterized with a given passenger while driving during the day.

The table entries or values 710 may reflect the performance indicator tracked for the table, e.g., the smoothness of driving, percentage of distracted driving, average distracted headway, miles between events, driver score, etc., or any combination thereof, or may reflect the compatibility score derived therefrom.

The table values 710 preferably reflect the performance deterioration/improvement of driving performance when certain drivers are teamed with certain passengers. Some passengers may consistently worsen driving performance, while others may be consistently supportive, improving driving performance, even over a driver alone. It will be understood, however, that the drivers of driving teams are generally part-time passengers, and vice versa. For those entries that identify unacceptable driving performance, the corresponding driving team compositions may not be recommended. For the remainder, best driving team compositions may be determined as solutions to the assignment problem, which may result in a ranked or otherwise valued representation of the driving team compositions. The acceptable/unacceptable determinations may be made via comparison to one or more thresholds, which may be associated with the performance indicator tracked for the table. Performance changes may be tracked with time, e.g. by periodic re-evaluation of the performance table, and target coaching of both the driver and passenger be undertaken.

In at least one embodiment, the performance table 700 may indicate that there is a deterioration in performance of multiple driving teams that have a common passenger. This is the case, for example, if the presence of passenger X worsens the performance of drivers P, Q and R, when compared to their respective driver-only baselines, in excess of some unacceptable amount. In such a case, it can be determined that passenger X should not be part of any driving team. A given passenger (and then part-time driver) may further be coached to reduce his performance worsening effects. Such coaching may take the form of additional training and/or vehicle systems intervention (e.g., a warning light identifying correctable behavior to the passenger in substantively real-time).

A max/min or average/median value analysis of the performance table 700 may also be used in this way to determine whether the common passenger is not to be recommended for any driving team. For example, when the max/min and/or average/mean values of the performance table exceed a predetermined threshold, the passenger may not be recommended for any driving team. That is, for example, if the average reduction in performance for a given passenger is above some value, it may be desirable to have this person drive alone, or at least not with any of the drivers in the table. A least-bad′ solution would be to have this passenger team with the least distractable, performance reduced driver.

The recommendations may also generalize from an analysis of a subset of driving teams, as opposed to an analysis of all possible driving teams. Thus, for example, all driving teams including passenger X need not be considered before it is determined that passenger X should not be recommended as part of any driving team.

In at least one embodiment, the analysis of the performance table 700 includes a recommender system approach, such as, collaborative filtering, content based filtering, etc. In such approaches, the performance-based data, the performance events, the performance propensities and/or the compatibility scores, which contribute to the performance table 700, are analyzed to determine potential causes for the resulting table values (e.g., why certain passengers team well with some drivers and not others). Accordingly, it can be determined that the propensity towards performance deterioration with respect to one or more performance indicators increases/decreases under certain sets of circumstances and/or performance affecting events.

For example, such analysis may indicate a propensity for silence/conversation, an ability/inability to multitask (e.g., due to consistent performance deterioration when other behaviors or circumstances are present), good/poor peripheral vision (e.g., due to a propensity for gaze diversions), etc. Such analysis may also, or alternatively, indicate that for some driving teams a propensity for conversation improves performance (e.g., by keeping the driver alert and vigilant). Accordingly, for example, while excessive or loud talking may result in a recommendation against some driving teams whose performance suffers from such talking, it may nevertheless result in a recommendation in favor of other driving teams whose performance benefits from such talking.

In this manner, driving team recommendations may be made that account for the performance effects that performance affecting behaviors and/or circumstances have on specific driving teams. Such driving team recommendations may also include for example, team compositions pairing according to temperament (e.g., anodyne or non-distracting passengers with not-easily-distracted drivers, etc.), pairing according to driving excursion circumstances (e.g., urban drivers with open highway drivers, daytime drivers with nighttime drivers, etc.), or according to any other propensities and/or performances desired. Other analysis may be also be performed to determine recommendations for driving team compositions.

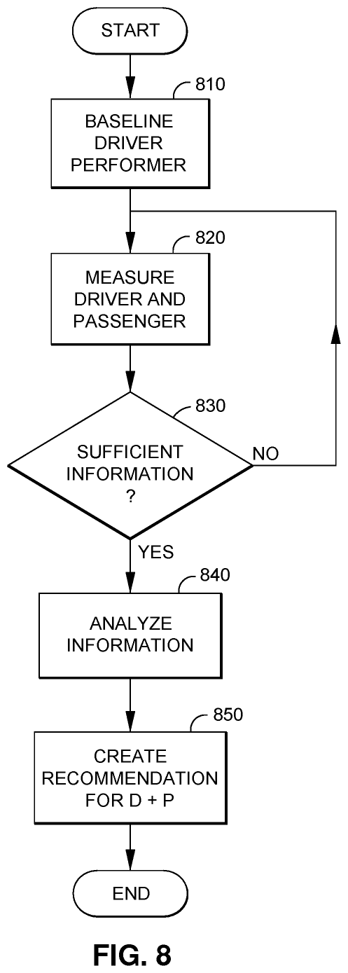

FIG. 8 illustrates an exemplary method for determining the driving team recommendation(s) for an exemplary driving team, according to at least one embodiment. It will be understood that the method can be performed with respect to any driving team, including the driver-only driving team.

In step 810, baseline performance is determined for the driver-only team, as described herein. In particular, the performance-based data for one or more performance indicators may collected and analyzed to determine baseline performance propensities for such performance indicators. Alternatively, or additionally, the baseline may reflect a theoretical reference model performance stored in the database.

In step 820, the performance-based data is collected for the driver and passenger driving team, as described herein. In particular, the performance-based data for the one or more performance indicators may collected and analyzed to determine the performance propensities for such indicators.

In step 830, it is determined whether sufficient performance-based data has been collected in order for the performance propensities to be determined. In the event that additional performance-based data is required, the process returns to step 820.

In step 840, the performance-based data is analyzed to determine the performance propensities and/or the compatibility scores therefrom, as described herein. In particular, the performance propensities and/or compatibility scores may be determined based on, for example, deviations between the performance-based data collected for the driver and passenger driving team, on one hand, and the baseline driver-only driving team, on the other hand. The performance table may further be populated so as to reflect the performance propensities and/or compatibility scores for a plurality of driving teams.

In step 850, one or more driving team composition recommendations may be generated based on an analysis of the performance propensities and/or compatibility scores generated in step 840. Information regarding the recommendations for driving team composition may be recorded in a separate recommendation table (not shown). The recommendation table may be similar to the performance table 700, except that the entries may reflect recommendations determined from the performance table (and/or related performance-related data, events and/or propensities). For example, the recommendation table may have a do-not-pair indicator as the table value where analysis of the corresponding performance table, or tables, indicate that the composition should not be recommended. The recommendation table may be stored in the database and utilized, for example, in the control of one or more vehicle systems. For instance, where gaze distraction is detected, a distance warning threshold may be increased, supportive braking may be started at an earlier than usual for the driver alone, etc.

In general, the detected performance events and/or driving team compositions may be relied on by the vehicle-systems control module 260 in controlling one or more vehicle systems. Such control may occur directly in response to detected performance events and/or driving team compositions communicated in-vehicle among the architecture components. Additionally, or alternatively, such control may occur indirectly, in response to control signals received from the remote location/device, which may generate the control signals in response to receiving a signal identifying the detected events and/or driving team compositions from the event monitoring and reporting system.

Examples of vehicle controls that may be initiated based on detected performance events and/or driving team compositions include, but are not limited to, event-based data recording, saving and/or transmission, outputting visual and/or audio driver warnings (e.g., via driver assistance systems, etc.), adjusting thresholds for safety and other event detection (e.g., lane-departure warning thresholds adjusted to account for decreased reaction time due to detected distraction event, headway warning thresholds adjusted to account for propensity for driving pair to follow too closely, etc.), and authorizing vehicle operations (e.g., preventing ignition where a non-recommended driving team is detected, etc.).

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system, comprising:
one or more sensors configured to capture performance-based data characterizing driving-performance implicating behaviors of a driving team during one or more driving campaigns;
at least one control unit configured to:
determine a compatibility score for the driving team from the performance-based data; and
control one or more vehicle functions based on the compatibility score.

2. The system of claim 1, wherein the driving-performance implicating behaviors are defined according to one or more of: face direction, gaze direction, hand activity, and speech.

3. The system of claim 1, wherein the driving-performance implicating behaviors are defined according to one or more of: speed, following distance or time, steering wheel operation, brake operation, turn signal operation, and throttle operation.

4. The system of claim 1, wherein the performance-based data is captured gaze direction and duration; and wherein the compatibility score is a proxy for driver attention/inattention determined based on the gaze direction and duration data.

5. The system of claim 1, wherein the compatibility score reflects a driving performance cost of the driving team.

6. The system of claim 1, wherein the compatibility score is determined by comparing the performance-based data of the driving team with the performance-based data of at least one other driving team.

7. The system of claim 6, wherein the at least one other driving team is a driver-only team.

8. The system of claim 1, wherein the at least one control unit is further configured to:
determine one or more performance propensities from the performance-based data, wherein the compatibility score is determined by comparing the performance propensities of the driving team with the performance propensities of at least one other driving team.

9. The system of claim 8, wherein the at least one other driving team is a driver-only team.

10. The system of claim 1, wherein the at least one control unit is further configured to:
optimize driving team compositions based on the compatibility scores of a plurality of driving teams.

11. A method, comprising:
capturing, via one or more sensors, performance-based data characterizing driving-performance implicating behaviors of a driving team during one or more driving campaigns;
determine, via at least one control unit, a compatibility score for the driving team from the performance-based data; and
controlling, via the at least one control unit, one or more vehicle functions based on the compatibility score.

12. The method of claim 11, wherein the driving-performance implicating behaviors are defined according to one or more of: face direction, gaze direction, hand activity, and speech.

13. The method of claim 11, wherein the driving-performance implicating behaviors are defined according to one or more of: following distance or time, steering wheel operation, and throttle operation.

14. The method of claim 11, wherein the performance-based data is captured gaze direction and duration; and wherein the compatibility score is a proxy for driver attention/inattention determined based on the gaze direction and duration data.

15. The method of claim 11, wherein the compatibility score reflects a driving performance cost of the driving team.

16. The method of claim 11, wherein the compatibility score is determined by comparing the performance-based data of the driving team with the performance-based data of at least one other driving team.

17. The method of claim 16, wherein the at least one other driving team is a driver-only team.

18. The method of claim 11, wherein the method further comprises:
determining, via the at least one control unit, one or more performance propensities from the performance-based data, wherein the compatibility score is determined by comparing the performance propensities of the driving team with the performance propensities of at least one other driving team.

19. The method of claim 18, wherein the at least one other driving team is a driver-only team.

20. The method of claim 11, further comprising:
optimizing, via the at least one control unit, driving team compositions and/or task sequencing based on the compatibility scores of a plurality of driving teams.
